(19) United States
(12) Patent Application Publication
(10) Pub. No.: US 2026/0094877 A1
(43) Pub. Date: Apr. 2, 2026

(54) ELECTRODE GROUP AND SECONDARY BATTERY

(71) Applicant: KABUSHIKI KAISHA TOSHIBA, Kawasaki-shi (JP)

(72) Inventors: Masato YANAGI, Yokohama Kanagawa (JP); Naoki NISHIO, Yokohama Kanagawa (JP); Takatoshi KASUKABE, Yokohama Kanagawa (JP)

(73) Assignee: KABUSHIKI KAISHA TOSHIBA, Kawasaki-shi (JP)

(21) Appl. No.: 19/389,267

(22) Filed: Nov. 14, 2025

Related U.S. Application Data
(63) Continuation of application No. PCT/JP2024/044102, filed on Dec. 12, 2024.

(30) Foreign Application Priority Data
Sep. 30, 2024 (JP) 2024-169947

(51) Int. Cl. H01M 10/0587; H01M 10/052; H01M 50/434; H01M 50/443

(52) U.S. Cl. CPC H01M 10/0587; H01M 10/052; H01M 50/434; H01M 50/443

(57) ABSTRACT

An electrode group includes a positive electrode and a negative electrode wound together with a separator. The positive electrode includes a band-shaped current collector having a long side and a short side, a positive mixture layer applied parallel to the long side, a non-coated portion without the mixture, and an insulating portion covering the interface between the coated and non-coated areas. The negative electrode also has a band-shaped current collector and a negative mixture layer applied parallel to its long side. The insulating portion includes a first region covering part of the non-coated area and a second region covering part of the positive mixture layer. An end of the negative mixture layer, which extends parallel to its long side, is positioned to face the second region of the insulating portion.

### CROSS-REFERENCE TO RELATED APPLICATIONS

This application is a Continuation application of prior International Application No. PCT/JP2024/044102 filed on Dec. 12, 2024.

This application is based upon and claims the benefit of priority from Japanese Patent Application No. 2024-169947, filed Sep. 30, 2024, the entire contents of which are incorporated herein by reference.

### FIELD

Embodiments describes herein relate generally to an electrode group and a secondary battery.

### BACKGROUND

In recent years, secondary batteries such as lead-acid batteries and nickel-metal hydride batteries have been used as power sources represented by electric vehicles, hybrid vehicles, electric motorcycles, forklifts, and the like. Recently, development toward adoption of a lithium ion secondary battery having a high energy density has been actively conducted, and development has been conducted in consideration of long life, safety, and the like.

For example, in a lithium ion secondary battery (hereinafter, referred to as a secondary battery), in order to receive all lithium ions supplied from a positive mixture layer, the width of a negative mixture layer may be formed wider than the width of the positive mixture layer, and the area of the negative mixture layer may be formed larger than the area of the positive mixture layer. In such a type of secondary battery, the negative mixture layer has a portion facing a positive mixture layer non-coated portion (positive electrode current collector) in which the positive mixture layer is not applied with a separator interposed therebetween. In the portion where the negative mixture layer and the positive mixture layer non-coated portion face each other, an end portion of the negative mixture layer breaks through the separator, and the negative mixture layer and the positive mixture layer non-coated portion (positive electrode current collector) are in electrical contact with each other, so that a short circuit may occur.

### BRIEF DESCRIPTION OF THE DRAWINGS

FIG. 1 is a perspective view schematically showing an electrode group according to a first embodiment.

FIG. 2 is a partially exploded perspective view of the electrode group according to the first embodiment viewed from above.

FIG. 3 is a cross-sectional view schematically showing the electrode group according to the first embodiment.

FIG. 4 is a cross-sectional view schematically showing a part including an insulating portion of a positive electrode used for the electrode group according to the first embodiment.

FIG. 5 is an enlarged cross-sectional view including one insulating portion in the positive electrode used for the electrode group according to the first embodiment.

FIG. 6 is a perspective view schematically showing an electrode group according to a second embodiment.

FIG. 7 is a partially exploded perspective view of the electrode group according to the second embodiment viewed from above.

FIG. 8 is a cross-sectional view schematically showing the electrode group according to the second embodiment.

FIG. 9 is a cross-sectional view schematically showing a part including an insulating portion of a positive electrode used for the electrode group according to the second embodiment.

FIG. 10 is an enlarged cross-sectional view including one insulating portion in the positive electrode used for the electrode group according to the second embodiment.

FIG. 11 is a perspective view schematically showing a secondary battery according to a third embodiment.

FIG. 12 is a perspective view schematically showing a secondary battery according to a fourth embodiment.

### DETAILED DESCRIPTION

Hereinafter, an electrode group and a secondary battery according to an embodiment will be described with reference to the drawings.

### First Embodiment

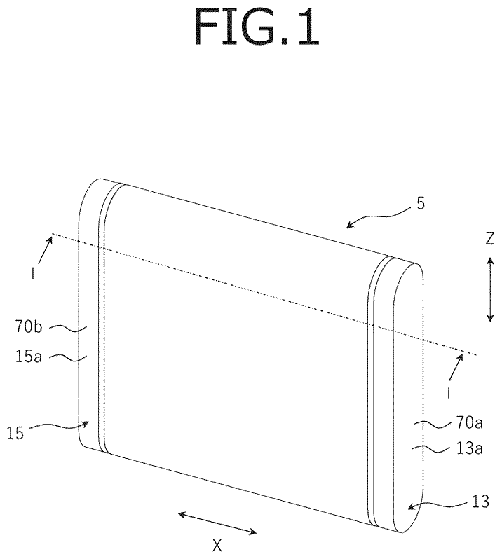

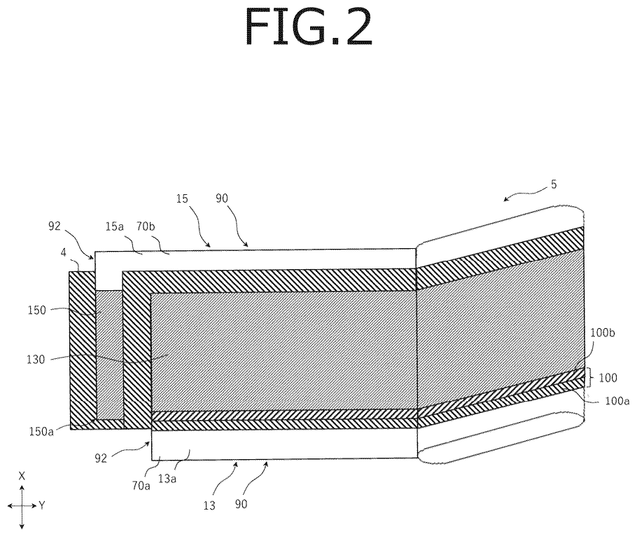

An electrode group 5 of a first embodiment will be described with reference to FIGS. 1 and 2. FIG. 1 is a perspective view schematically showing the electrode group 5 according to the first embodiment. FIG. 2 is a partially exploded perspective view of the electrode group 5 according to the first embodiment viewed from above.

For example, as shown in FIGS. 1 and 2, the electrode group 5 is manufactured by winding a positive electrode 13 and a negative electrode 15 with a separator 4 interposed therebetween and pressure-molding the whole into a flat shape.

The positive electrode 13 includes a band-shaped positive electrode current collector 13a having a long side 90 (Y direction) and a short side 92 (X direction). On the positive electrode current collector 13a, a positive mixture layer 130 in which a positive mixture is applied in parallel with the long side 90 and a positive mixture layer non-coated portion 70a in which the positive mixture is not applied are formed. The negative electrode 15 includes a band-shaped negative electrode current collector 15a having a long side 90 and a short side 92. On the negative electrode current collector 15a, a negative mixture layer 150 in which a negative mixture is applied in parallel with the long side 90 and a negative mixture layer non-coated portion 70b in which the negative mixture is not applied are formed.

In the electrode group 5 having a wound structure, the positive mixture layer non-coated portion 70a protrudes in a direction opposite to the protruding direction of the negative mixture layer non-coated portion 70b, and the positive mixture layer non-coated portion 70a and the negative mixture layer non-coated portion 70b are provided at both ends of the electrode group 5, but the protruding directions of the positive mixture layer non-coated portion 70a and the negative mixture layer non-coated portion 70b are not limited thereto. The positive mixture layer non-coated portion 70a and the negative mixture layer non-coated portion 70b may protrude in the same direction, and both may be provided at one end of the electrode group 5.

In the electrode group 5 of the present embodiment, an insulating portion 100 covering an interface between the positive mixture layer non-coated portion 70a and the positive mixture layer 130 is formed on the positive electrode current collector 13a. The insulating portion 100 has a first region 100a covering at least a part of the positive mixture layer non-coated portion 70a and a second region 100b covering at least a part of the positive mixture layer 130.

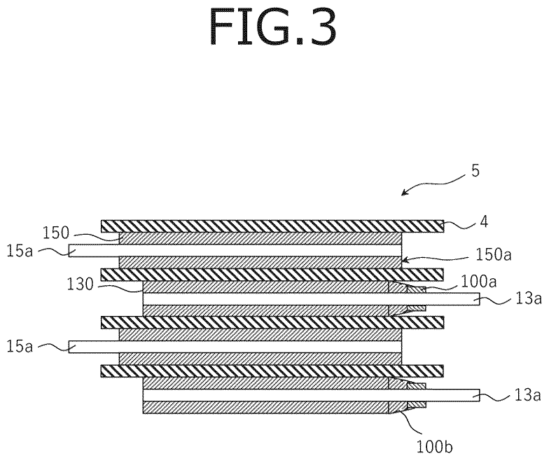

The cross section (I-I cross section shown in FIG. 1) of the electrode group 5 will be described with reference to FIG. 3. FIG. 3 is a cross-sectional view schematically showing the electrode group 5 according to the first embodiment. As shown in FIG. 3, in the case of the electrode group 5 having a wound structure, an end portion 150a parallel to the long side 90 of the negative mixture layer 150 is provided at a position facing the second region 100b of the insulating portion 100. As a result, even when the end portion 150a of the negative mixture layer 150 breaks through the separator 4, the second region 100b of the insulating portion 100 faces the end portion 150a of the negative mixture layer 150, and thus it is possible to suppress electrical contact between the negative mixture layer 150 and the positive electrode current collector 13a which is the positive mixture layer non-coated portion 70a, that is, a short circuit.

The end portion 150a of the negative mixture layer 150 faces the second region 100b of the insulating portion 100, and the second region 100b of the insulating portion 100 covers the positive mixture layer 130. Here, the second region 100b of the insulating portion 100 and the positive mixture layer 130 are present at a position facing the end portion 150a of the negative mixture layer 150.

In the positive mixture layer 130 at the position facing the end portion 150a of the negative mixture layer 150, the elution of metal ions contained in the positive mixture layer 130 may occur, and the self-discharge of the positive electrode 13 may proceed. However, by covering at least a part of the positive mixture layer 130 with the second region 100b of the insulating portion 100, the elution of the metal ions contained in the positive mixture layer 130 can be suppressed. As a result, it is possible to obtain the electrode group 5 securing a sufficient capacity while suppressing the self-discharge of the positive electrode 13.

The first region 100a of the insulating portion 100 is in contact with the second region 100b of the insulating portion 100, but for example, even when shear in winding between the positive electrode 13 and the negative electrode 15 occurs in the manufacture of the electrode group 5 having a wound structure, the first region 100a of the insulating portion 100 faces the end portion 150a of the negative mixture layer 150, and a short circuit between the negative mixture layer 150 and the positive mixture layer non-coated portion 70a of the positive electrode current collector 13a can be suppressed.

The insulating portion 100 will be described. The insulating portion 100 contains at least one kind of insulating particles. Examples of the insulating particles include solid particles of metal oxide, such as aluminum oxide (alumina), zirconium oxide (zirconia), magnesium oxide, and barium sulfate. The most preferable insulating particles are alumina or zirconia particles, and the insulating portion 100 can be formed inexpensively and easily.

The insulating portion 100 may contain not only the insulating particles but also a binder. As the binder, polytetrafluoroethylene, polyvinylidene fluoride, fluorine rubber, styrene-butadiene rubber, polyacrylate compounds, imide compounds, and carboxymethyl cellulose and the like can be used. One of them may be used as the binder, or two or more of them may be used in combination.

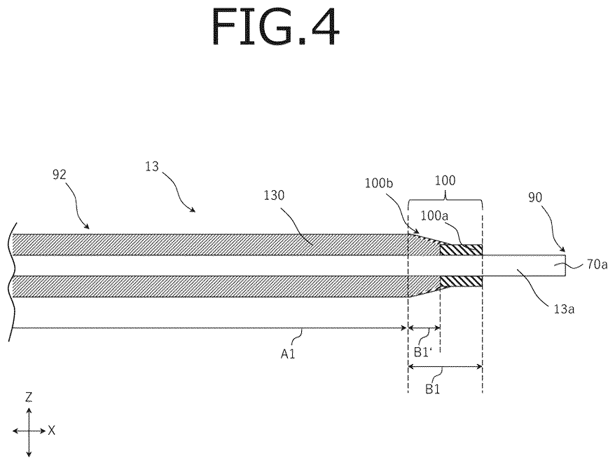

The structure of the insulating portion 100 will be described with reference to FIG. 4. FIG. 4 is a cross-sectional view schematically showing a part including the insulating portion 100 of the positive electrode 13 used for the electrode group 5 according to the first embodiment.

As described above, the insulating portion 100 covering the interface between the positive mixture layer non-coated portion 70a and the positive mixture layer 130 is formed on the positive electrode current collector 13a. Here, as shown in FIG. 4, in the positive electrode 13 used for the electrode group 5 having a wound structure, the length of the positive mixture layer 130 not covered with the insulating portion 100 in the width direction (X direction) parallel to the short side 92 of the positive mixture layer 130 is A1, and the length of the insulating portion 100 in the width direction (X direction) is B1. Here, the relationship (B1/A1) between the length A1 and the length B1 is preferably 0.01 or more and 0.04 or less.

When the relationship (B1/A1) between the length A1 of the positive mixture layer 130 not covered with the insulating portion 100 and the length B1 of the insulating portion 100 is 0.01 or more, the length B1 of the insulating portion 100 is sufficient with respect to the length A1 of the positive mixture layer 130 not covered with the insulating portion 100, the second region 100b of the insulating portion 100 faces the end portion 150a of the negative mixture layer 150, and a short circuit between the negative mixture layer 150 and the positive mixture layer non-coated portion 70a can be suppressed. When the relationship (B1/A1) between the length A1 of the positive mixture layer 130 not covered with the insulating portion 100 and the length B1 of the insulating portion 100 is 0.04 or less, the ratio of the insulating portion 100 to the entire electrode group 5 is appropriate, and the electrode group 5 securing a sufficient capacity can be obtained.

A more preferable relationship (B1/A1) between the length A1 of the positive mixture layer 130 not covered with the insulating portion 100 and the length B1 of the insulating portion 100 is 0.015 or more and 0.04 or less. When the relationship (B1/A1) between the length A1 of the positive mixture layer 130 not covered with the insulating portion 100 and the length B1 of the insulating portion 100 is 0.015 or more, a short circuit between the negative mixture layer 150 and the positive mixture layer non-coated portion 70a can be further suppressed as compared with the case where the relationship (B1/A1) between the length A1 of the positive mixture layer 130 not covered with the insulating portion 100 and the length B1 of the insulating portion 100 is 0.01.

Furthermore, as shown in FIG. 4, in the positive electrode 13 used for the electrode group 5 having a wound structure, the length of the second region 100b of the insulating portion 100 in the width direction (X direction) of the positive mixture layer 130 is taken as B1′. Here, the relationship (B1′/B1) between the length B1 and length B1′ is preferably 0.1 or more and 0.5 or less. When the relationship (B1′/B1) between the length B1 of the insulating portion 100 and the length B1′ of the second region 100b of the insulating portion 100 is 0.1 or more, the elution of metal ions contained in the positive mixture layer 130 can be suppressed in the positive mixture layer 130 at a position facing the end portion 150a of the negative mixture layer 150, and the electrode group 5 securing a sufficient capacity can be obtained.

By setting the relationship (B1′/B1) between the length B1 of the insulating portion 100 and the length B1′ of the second region 100b of the insulating portion 100 to 0.5 or less, it is possible to obtain the electrode group 5 securing a sufficient capacity without affecting the pressing step of the positive electrode 13, and to set an appropriate pressing pressure. The spreadability of the insulating portion 100 may affect the pressing step of the positive electrode 13, and details thereof will be described below.

As described above, the insulating portion 100 contains insulating particles such as alumina and zirconia particles, and may have worse spreadability than that of the positive mixture layer 130. Therefore, for example, in the step of pressing the positive electrode 13, the second region 100b of the insulating portion 100 may be less likely to be crushed than the positive mixture layer 130. When the second region 100b of the insulating portion 100 is less likely to be crushed than the positive mixture layer 130 in the pressing step, the electrode thickness of the entire positive electrode 13 increases, so that the number of windings of the electrode group 5 may decrease and the capacity of the electrode group 5 may decrease. The second region 100b of the insulating portion 100 may have worse spreadability than that of the positive mixture layer 130, and thus when the second region 100b of the insulating portion 100 is formed to be wide in the width direction (X direction), a large pressing pressure is required to press the wide second region 100b of the insulating portion 100. Therefore, in order to ensure a sufficient capacity without affecting the pressing step of the positive electrode 13 and to set an appropriate pressing pressure, it is necessary to appropriately control the length of the second region 100b of the insulating portion 100, and in the present embodiment, the relationship (B1′/B1) between the length B1 of the insulating portion 100 and the length B1′ of the second region 100b of the insulating portion 100 is preferably 0.5 or less.

A more preferable relationship (B1′/B1) between the length B1 of the insulating portion 100 and the length B1′ of the second region 100b of the insulating portion 100 is 0.1 or more and 0.3 or less. When the relationship (B1′/B1) between the length B1 of the insulating portion 100 and the length B1′ of the second region 100b of the insulating portion 100 is 0.3 or less, as compared with the case where the relationship (B1′/B1) between the length B1 of the insulating portion 100 and the length B1′ of the second region 100b of the insulating portion 100 is 0.5, the electrode group 5 securing a more sufficient capacity can be obtained, and a more appropriate pressing pressure can be set.

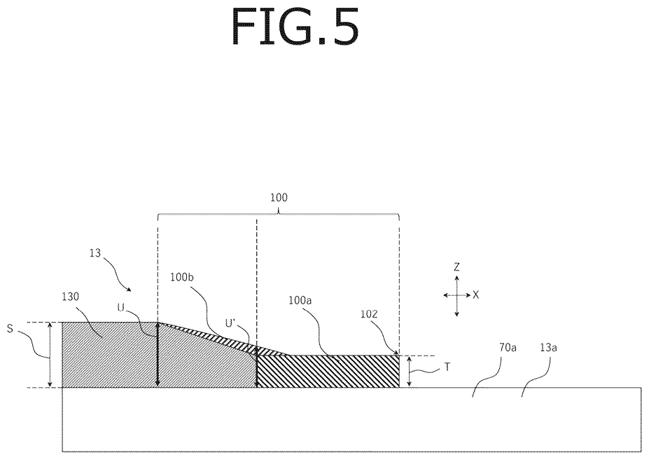

The structure of the insulating portion 100 will be further described with reference to FIG. 5. FIG. 5 is an enlarged cross-sectional view including one insulating portion 100 in the positive electrode 13 used for the electrode group 5 according to the first embodiment.

As shown in FIG. 5, in the positive electrode 13 used for the electrode group 5, a thickness direction (Z direction) orthogonal to the width direction (X direction) of the positive mixture layer 130 is defined. Here, when the thickness of the positive mixture layer 130 not covered with the insulating portion 100 is taken as S and the thickness of the first region 100a of the insulating portion 100 is taken as T, the thickness (S) of the positive mixture layer 130 not covered with the insulating portion 100 is larger than the thickness (T) of the first region 100a of the insulating portion 100. Here, the thickness S is a thickness at the thickest position among three arbitrary positions selected in the positive mixture layer 130. The thickness T is defined as the thickness of the end portion 102 in the first region 100a of the insulating portion 100.

As described above, the insulating portion 100 contains insulating particles such as alumina and zirconia particles, and may have worse spreadability than that of the positive mixture layer 130. Therefore, for example, in the step of pressing the positive electrode 13, by forming the thickness (S) of the positive mixture layer 130 not covered with the insulating portion 100 to be larger than the thickness (T) of the first region 100a of the insulating portion 100, the pressing pressure can be sufficiently applied to the positive mixture layer 130 not covered with the insulating portion 100. By reducing the electrode thickness of the entire positive electrode 13 by the pressing step, the number of windings of the electrode group 5 can be increased, and the electrode group 5 having a sufficient capacity can be obtained.

In the present embodiment, in the case of the electrode group 5 having a wound structure, the end portion 150a parallel to the long side 90 of the negative mixture layer 150 is provided at a position facing the second region 100b of the insulating portion 100, but the first region 100a of the insulating portion 100 may face the end portion 150a of the negative mixture layer 150 due to shear in winding between the positive electrode 13 and the negative electrode 15. Since the first region 100a of the insulating portion 100 is not involved in the capacity of the electrode group 5 and is formed for suppressing a short circuit between the negative mixture layer 150 and the positive mixture layer non-coated portion 70a, the thickness (T) of the first region 100a of the insulating portion 100 may be less than the thickness (S) of the positive mixture layer 130. Even if the thickness (T) of the first region 100a of the insulating portion 100 is formed to be less than the thickness (S) of the positive mixture layer 130, a short circuit between the negative mixture layer 150 and the positive mixture layer non-coated portion 70a can be suppressed when the first region 100a of the insulating portion 100 faces the end portion 150a of the negative mixture layer 150, and the manufacturing cost of the insulating portion 100 can be reduced since the thickness (T) of the first region 100a is smaller than the thickness (S) of the positive mixture layer 130.

Furthermore, as shown in FIG. 5, at the interface between the positive mixture layer 130 not covered with the insulating portion 100 and the positive mixture layer 130 covered with the second region 100b of the insulating portion 100, the total thickness of the positive mixture layer 130 covered with the second region 100b of the insulating portion 100 and the second region 100b is taken as U. At the interface between the positive mixture layer 130 covered with the second region 100b of the insulating portion 100 and the first region 100a of the insulating portion 100, the total thickness of the positive mixture layer 130 covered with the second region 100b of the insulating portion 100 and the second region 100b is taken as U′.

Here, the total thickness (U) of the positive mixture layer 130 covered with the second region 100b of the insulating portion 100 and the second region 100b is larger than the total thickness (U′) of the positive mixture layer 130 covered with the second region 100b of the insulating portion 100 and the second region 100b. The total thickness (U) of the positive mixture layer 130 covered with the second region 100b of the insulating portion 100 and the second region 100b is formed so as to be less toward the total thickness (U′) of the positive mixture layer 130 covered with the second region 100b of the insulating portion 100 and the second region 100b, that is, toward the first region 100a of the insulating portion 100 (toward the width direction X), and has a cross-sectional inclined structure.

As described above, by forming the thickness (S) of the positive mixture layer 130 not covered with the insulating portion 100 to be larger than the thickness (T) of the first region 100a of the insulating portion 100, the pressing pressure can be sufficiently applied to the positive mixture layer 130 not covered with the insulating portion 100, and the manufacturing cost of the insulating portion 100 can be reduced. Although the thickness (S) of the positive mixture layer 130 is formed to be larger than the thickness (T) of the first region 100a of the insulating portion 100, the second region 100b of the insulating portion 100 covers the positive mixture layer 130. The total thickness (U) of the positive mixture layer 130 covered with the second region 100b of the insulating portion 100 and the second region 100b has a cross-sectional inclined structure toward the total thickness (U′) of the positive mixture layer 130 covered with the second region 100b of the insulating portion 100 and the second region 100b so that the thin insulating portion 100 easily covers the positive mixture layer 130 thicker than the insulating portion 100.

In the positive electrode 13 of the present embodiment, a part of the insulating portion 100 may be formed between the positive mixture layer 130 and the positive electrode current collector 13a.

The material of the electrode group 5 of the present embodiment will be described. The negative mixture layer 150 preferably contains a compound having a lithium ion insertion/extraction potential of 0.4 V (vs. Li/Li+) or more as a potential based on metal lithium, but is not limited thereto. Such a negative mixture layer 150 can suppress the precipitation of lithium metal due to charging and discharging, and the precipitated lithium metal does not break through the separator 4, so that a short circuit between the positive electrode 13 and the negative electrode 15 can be suppressed.

A specific preferable compound in the negative mixture layer 150 is lithium titanate having a spinel type crystal structure represented by Li4+xTi5O12 (−1≤x≤3), lithium titanate having a ramsdellite-type crystal structure represented by Li2+xTi3O7 (−1≤x≤3), a niobium-titanium composite oxide having a monoclinic crystal structure represented by LixNb2TiO7 (0≤x≤5), and a metal composite oxide containing Ti and at least one element selected from the group consisting of P, V, Sn, Cu, Ni, and Fe, and the like. The negative mixture layer 150 preferably contains at least one of these compounds.

The most preferable compound in the negative mixture layer 150 is lithium titanate having a spinel type crystal structure or lithium titanate having a ramsdellite-type crystal structure. In the electrode group 5 of the present embodiment, the second region 100b of the insulating portion 100 faces the end portion 150a of the negative mixture layer 150, and a short circuit between the negative mixture layer 150 and the positive mixture layer non-coated portion 70a can be suppressed, but there is a possibility that the end portion 150a of the negative mixture layer 150 may break through not only the separator 4 but also the second region 100b of the insulating portion 100 by any chance. When the end portion 150a of the negative mixture layer 150 also breaks through the second region 100b of the insulating portion 100, the end portion 150a of the negative mixture layer 150 may come into contact with the positive mixture layer 130 to cause a short circuit. Even in this case, if lithium titanate is contained in the negative mixture layer 150, lithium titanate at a short circuit point is insulated, and a short circuit current can be suppressed. As a result, even if the end portion 150a of the negative mixture layer 150 comes into contact with the positive mixture layer 130 by any chance and a short circuit occurs, a large current due to the short circuit can be suppressed, and the safety of the electrode group 5 can be secured.

The positive mixture layer 130 contains, for example, LixMn2O4 (0<x≤1) having a spinel structure, a lithium-manganese composite oxide of LixMnO2 (0<x≤1), a lithium-nickel-aluminum composite oxide of LixNi1-yAlyO2 (0<x≤1, 0<y<1), a lithium-cobalt composite oxide of LixCoO2 (0<x≤1), a lithium-nickel-cobalt-manganese composite oxide of LixNi1-y-zCoyMnzO2 (0<x≤1, 0<y<1, 0≤z<1), a lithium-manganese-cobalt composite oxide of LixMnyCo1-yO2 (0<x≤1, 0<y<1), a spinel-type lithium-manganese-nickel composite oxide of LixMn1-yNiyO4 (0<x≤1, 0<y<2, 0<1−y<1), and the like.

In the electrode group 5 of the first embodiment described above, the end portion 150a of the negative mixture layer 150 is provided at a position facing the second region 100b of the insulating portion 100. As a result, even when the end portion 150a of the negative mixture layer 150 breaks through the separator 4, the second region 100b of the insulating portion 100 faces the end portion 150a of the negative mixture layer 150, and thus it is possible to suppress a short circuit between the negative mixture layer 150 and the positive mixture layer non-coated portion 70a.

In the electrode group 5 of the first embodiment, in the positive mixture layer 130 at the position facing the end portion 150a of the negative mixture layer 150, the second region 100b of the insulating portion 100 covers at least a part of the positive mixture layer 130. As a result, it is possible to obtain the electrode group 5 securing a sufficient capacity while suppressing the self-discharge of the positive electrode 13 due to the elution of the metal ions contained in the positive mixture layer 130.

### Second Embodiment

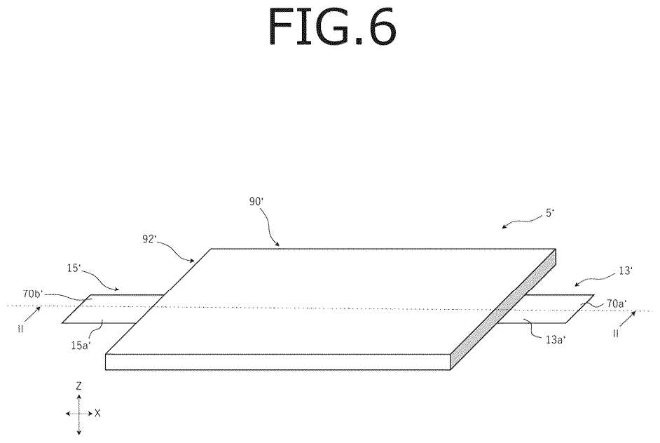

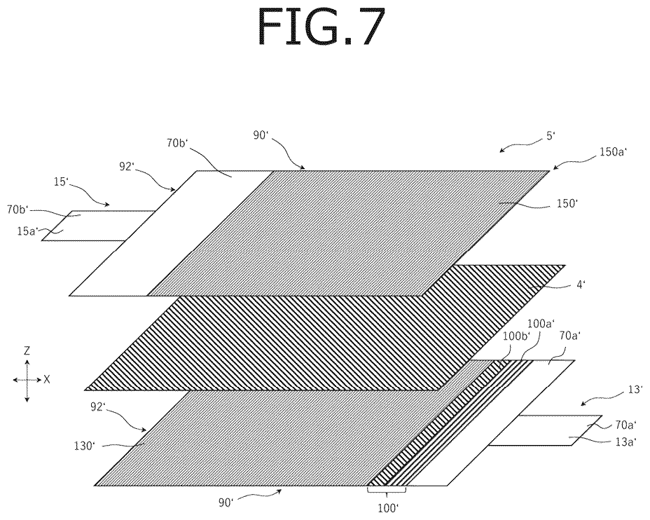

An electrode group 5′ of a second embodiment will be described with reference to FIGS. 6 and 7. FIG. 6 is a perspective view schematically showing the electrode group 5′ according to the second embodiment. FIG. 7 is a partially exploded perspective view of the electrode group 5′ according to the second embodiment viewed from above.

As shown in FIG. 6, the electrode group 5′ is manufactured by stacking a positive electrode 13′ and a negative electrode 15′ with a separator 4′ interposed therebetween. As shown in FIG. 7, the positive electrode 13′ includes a rectangular positive electrode current collector 13a′ having a long side 90′ and a short side 92′. On the positive electrode current collector 13a′, a positive mixture layer 130′ in which a positive mixture is applied in parallel with the short side 92′ and a positive mixture layer non-coated portion 70a′ in which the positive mixture is not applied are formed. The negative electrode 15′ includes a band-shaped negative electrode current collector 15a′ having a long side 90′ and a short side 92′. On the negative electrode current collector 15a′, a negative mixture layer 150′ in which a negative mixture is applied in parallel with the short side 92′ and a negative mixture layer non-coated portion 70b′ in which the negative mixture is not applied are formed.

In the electrode group 5′ of the present embodiment, an insulating portion 100′ covering an interface between the positive mixture layer non-coated portion 70a′ and the positive mixture layer 130′ is formed on the positive electrode current collector 13a′. The insulating portion 100′ has a first region 100a′ covering at least a part of the positive mixture layer non-coated portion 70a′ and a second region 100b′ covering at least a part of the positive mixture layer 130′.

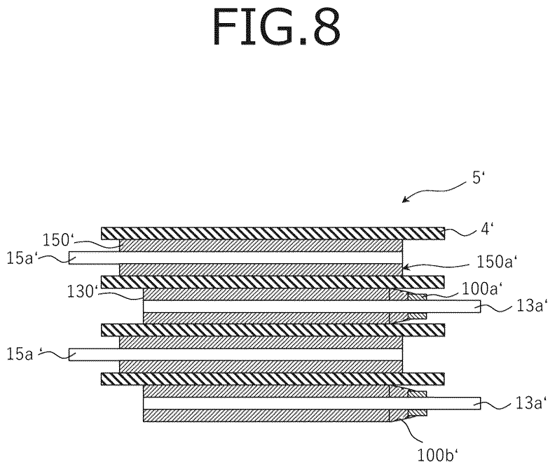

The cross section (II-II cross section shown in FIG. 6) of the electrode group 5′ will be described with reference to FIG. 8. FIG. 8 is a cross-sectional view schematically showing the electrode group 5′ according to the second embodiment. As shown in FIG. 8, in the case of the electrode group 5′ having a stacked structure, an end portion 150a′ parallel to the short side 92′ of the negative mixture layer 150′ is provided at a position facing the second region 100b′ of the insulating portion 100′. As a result, even when the end portion 150a′ of the negative mixture layer 150′ breaks through the separator 4′, the second region 100b′ of the insulating portion 100′ faces the end portion 150a′ of the negative mixture layer 150′, and thus it is possible to suppress a short circuit between the negative mixture layer 150′ and the positive mixture layer non-coated portion 70a′.

The end portion 150a′ of the negative mixture layer 150′ faces the second region 100b′ of the insulating portion 100′, and the second region 100b′ of the insulating portion 100′ covers the positive mixture layer 130′. Here, the second region 100b′ of the insulating portion 100′ and the positive mixture layer 130′ are present at a position facing the end portion 150a′ of the negative mixture layer 150′.

In the positive mixture layer 130′ at a position facing the end portion 150a′ of the negative mixture layer 150′, the elution of metal ions contained in the positive mixture layer 130′ may occur, and the self-discharge of the positive electrode 13′ may proceed. However, by covering at least a part of the positive mixture layer 130′ with the second region 100b′ of the insulating portion 100′, the elution of the metal ions contained in the positive mixture layer 130′ can be suppressed. As a result, it is possible to obtain the electrode group 5′ securing a sufficient capacity while suppressing the self-discharge of the positive electrode 13′.

The first region 100a′ of the insulating portion 100′ is in contact with the second region 100b′ of the insulating portion 100′, but for example, even when shear in stacking between the positive electrode 13′ and the negative electrode 15′ occurs in the manufacture of the electrode group 5′ having a stacked structure, the first region 100a′ of the insulating portion 100′ faces the end portion 150a′ of the negative mixture layer 150′, and a short circuit between the negative mixture layer 150′ and the positive mixture layer non-coated portion 70a′ can be suppressed.

The material of the insulating portion 100′ is similar to that of the insulating portion 100 of the first embodiment.

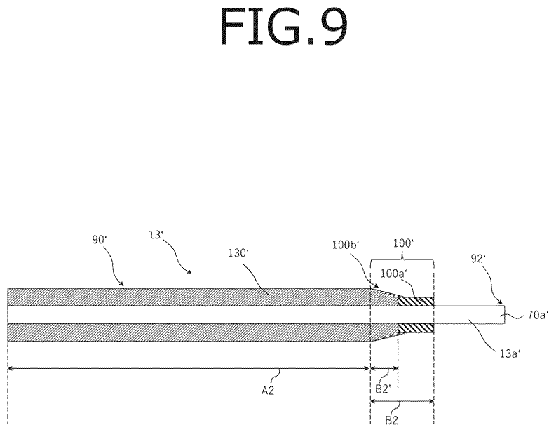

The structure of the insulating portion 100′ will be described with reference to FIG. 9. FIG. 9 is a cross-sectional view schematically showing a part including the insulating portion 100′ of the positive electrode 13′ used for the electrode group 5′ according to the second embodiment.

As described above, the insulating portion 100′ covering the interface between the positive mixture layer non-coated portion 70a′ and the positive mixture layer 130′ is formed on the positive electrode current collector 13a′. Here, as shown in FIG. 9, in the positive electrode 13′ used for the electrode group 5′ having a stacked structure, the length of the positive mixture layer 130′ not covered with the insulating portion 100′ in the width direction (X direction) parallel to the long side 90′ of the positive mixture layer 130′ is taken as A2, and the length of the insulating portion 100′ in the width direction (X direction) is taken as B2. Here, the relationship (B2/A2) between the length A2 and the length B2 is preferably 0.01 or more and 0.04 or less.

When the relationship (B2/A2) between the length A2 of the positive mixture layer 130′ not covered with the insulating portion 100′ and the length B2 of the insulating portion 100′ is 0.01 or more, the length B2 of the insulating portion 100′ is sufficient with respect to the length A2 of the positive mixture layer 130′ not covered with the insulating portion 100′, the second region 100b′ of the insulating portion 100′ faces the end portion 150a′ of the negative mixture layer 150′, and a short circuit between the negative mixture layer 150′ and the positive mixture layer non-coated portion 70a′ can be suppressed. When the relationship (B2/A2) between the length A2 of the positive mixture layer 130′ not covered with the insulating portion 100′ and the length B2 of the insulating portion 100′ is 0.04 or less, the ratio of the insulating portion 100′ to the entire electrode group 5′ is appropriate, and the electrode group 5′ securing a sufficient capacity can be obtained.

A more preferable relationship (B2/A2) between the length A2 of the positive mixture layer 130′ not covered with the insulating portion 100′ and the length B2 of the insulating portion 100′ is 0.015 or more and 0.04 or less. When the relationship (B2/A2) between the length A2 of the positive mixture layer 130′ not covered with the insulating portion 100′ and the length B2 of the insulating portion 100′ is 0.015 or more, a short circuit between the negative mixture layer 150′ and the positive mixture layer non-coated portion 70a′ can be further suppressed as compared with the case where the relationship (B2/A2) between the length A2 of the positive mixture layer 130′ not covered with the insulating portion 100′ and the length B2 of the insulating portion 100′ is 0.01.

As shown in FIG. 9, in the positive electrode 13′ used for the electrode group 5′ having a stacked structure, the length of the second region 100b′ of the insulating portion 100′ in the width direction (X direction) of the positive mixture layer 130′ is taken as B2′. Here, the relationship (B2′/B2) between the length B2 and the length B2′ is preferably 0.1 or more and 0.5 or less as in the relationship (B1′/B1) between the length B1 and the length B1′.

When the relationship (B2′/B2) between the length B2 of the insulating portion 100′ and the length B2′ of the second region 100b′ of the insulating portion 100′ is 0.1 or more, the elution of metal ions contained in the positive mixture layer 130′ can be suppressed in the positive mixture layer 130′ at a position facing the end portion 150a′ of the negative mixture layer 150′, and the electrode group 5′ securing a sufficient capacity can be obtained.

By setting the relationship (B2′/B2) between the length B2 of the insulating portion 100′ and the length B2′ of the second region 100b′ of the insulating portion 100′ to 0.5 or less, it is possible to obtain the electrode group 5′ securing a sufficient capacity without affecting the pressing step of the positive electrode 13′, and to set an appropriate pressing pressure. The spreadability of the insulating portion 100′ may affect the pressing step of the positive electrode 13, and details thereof will be described below.

As in the insulating portion 100 of the first embodiment, the insulating portion 100′ contains insulating particles such as alumina and zirconia particles, and may have worse spreadability than that of the positive mixture layer 130′. Therefore, for example, in the step of pressing the positive electrode 13′, the second region 100b′ of the insulating portion 100′ may be less likely to be crushed than the positive mixture layer 130′. When the second region 100b′ of the insulating portion 100′ is less likely to be crushed than the positive mixture layer 130′ in the pressing step, the electrode thickness of the entire positive electrode 13′ increases, so that the number of windings of the electrode group 5′ may decrease and the capacity of the electrode group 5′ may decrease. The second region 100b′ of the insulating portion 100′ may have worse spreadability than that of the positive mixture layer 130′, and thus when the second region 100b′ of the insulating portion 100′ is formed to be wide in the width direction (X direction), a large pressing pressure is required to press the wide second region 100b′ of the insulating portion 100′. Therefore, in order to ensure a sufficient capacity without affecting the pressing step of the positive electrode 13′ and to set an appropriate pressing pressure, it is necessary to appropriately control the length of the second region 100b′ of the insulating portion 100′, and in the present embodiment, the relationship (B2′/B2) between the length B2 of the insulating portion 100′ and the length B2′ of the second region 100b′ of the insulating portion 100′ is preferably 0.5 or less.

A more preferable relationship (B2′/B2) between the length B2 of the insulating portion 100′ and the length B2′ of the second region 100b of the insulating portion 100′ is 0.1 or more and 0.3 or less. When the relationship (B2′/B2) between the length B2 of the insulating portion 100′ and the length B2′ of the second region 100b of the insulating portion 100′ is 0.3 or less, as compared with the case where the relationship (B2′/B2) between the length B2 of the insulating portion 100′ and the length B2′ of the second region 100b′ of the insulating portion 100′ is 0.5, the electrode group 5′ securing a more sufficient capacity can be obtained, and a more appropriate pressing pressure can be set.

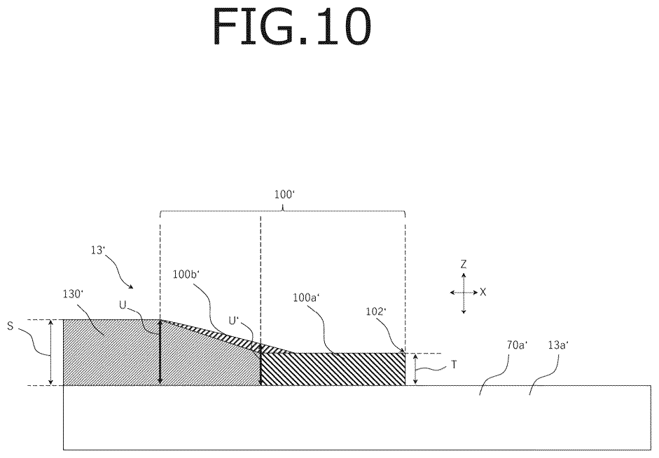

The structure of the insulating portion 100′ will be further described with reference to FIG. 10. FIG. 10 is an enlarged cross-sectional view including one insulating portion 100′ in the positive electrode 13′ used for the electrode group 5′ according to the second embodiment.

As shown in FIG. 10, in the positive electrode 13′ used for the electrode group 5′, a thickness direction (Z direction) orthogonal to the width direction (X direction) of the positive mixture layer 130′ is defined. Here, when the thickness of the positive mixture layer 130′ not covered with the insulating portion 100′ is taken as S and the thickness of the first region 100a′ of the insulating portion 100′ is taken as T, the thickness (S) of the positive mixture layer 130′ not covered with the insulating portion 100′ is larger than the thickness (T) of the first region 100a′ of the insulating portion 100′. Here, the thickness S is a thickness at the thickest position among three arbitrary positions selected in the positive mixture layer 130′. The thickness T is defined as the thickness of the end portion 102′ in the first region 100a′ of the insulating portion 100′.

As described above, the insulating portion 100′ contains insulating particles such as alumina and zirconia particles, and may have worse spreadability than that of the positive mixture layer 130′. Therefore, for example, in the step of pressing the positive electrode 13′, by forming the thickness (S) of the positive mixture layer 130′ not covered with the insulating portion 100′ to be larger than the thickness (T) of the first region 100a′ of the insulating portion 100′, the pressing pressure can be sufficiently applied to the positive mixture layer 130′ not covered with the insulating portion 100′. By reducing the electrode thickness of the entire positive electrode 13′ by the pressing step, the number of windings of the electrode group 5′ can be increased, and the electrode group 5′ having a sufficient capacity can be obtained.

In the present embodiment, in the case of the electrode group 5′ having a stacked structure, the end portion 150a′ parallel to the short side 92′ of the negative mixture layer 150′ is provided at a position facing the second region 100b′ of the insulating portion 100′, but the first region 100a′ of the insulating portion 100′ may face the end portion 150a′ of the negative mixture layer 150′ due to shear in stacking between the positive electrode 13′ and the negative electrode 15′. Since the first region 100a′ of the insulating portion 100′ is not involved in the capacity of the electrode group 5′ and is formed for suppressing a short circuit between the negative mixture layer 150′ and the positive mixture layer non-coated portion 70a′, the thickness (T) of the first region 100a′ of the insulating portion 100′ may be less than the thickness (S) of the positive mixture layer 130′. Even if the thickness (T) of the first region 100a′ of the insulating portion 100′ is formed to be less than the thickness (S) of the positive mixture layer 130′, a short circuit between the negative mixture layer 150′ and the positive mixture layer non-coated portion 70a′ can be suppressed when the first region 100a′ of the insulating portion 100′ faces the end portion 150a′ of the negative mixture layer 150′, and the manufacturing cost of the insulating portion 100′ can be reduced since the thickness (T) of the first region 100a′ is smaller than the thickness (S) of the positive mixture layer 130′.

Furthermore, as shown in FIG. 10, at the interface between the positive mixture layer 130′ not covered with the insulating portion 100′ and the positive mixture layer 130′ covered with the second region 100b′ of the insulating portion 100′, the total thickness of the positive mixture layer 130′ covered with the second region 100b′ of the insulating portion 100′ and the second region 100b′ is taken as U. At the interface between the positive mixture layer 130′ covered with the second region 100b′ of the insulating portion 100′ and the first region 100a′ of the insulating portion 100′, the total thickness of the positive mixture layer 130′ covered with the second region 100b′ of the insulating portion 100′ and the second region 100b‘ is taken as U’.

Here, the total thickness (U) of the positive mixture layer 130′ covered with the second region 100b′ of the insulating portion 100′ and the second region 100b′ is larger than the total thickness (U′) of the positive mixture layer 130′ covered with the second region 100b′ of the insulating portion 100′ and the second region 100b′. The total thickness (U) of the positive mixture layer 130′ covered with the second region 100b′ of the insulating portion 100′ and the second region 100b′ is formed so as to be less toward the total thickness (U′) of the positive mixture layer 130′ covered with the second region 100b′ of the insulating portion 100′ and the second region 100b′, that is, toward the first region 100a′ of the insulating portion 100′ (toward the width direction X), and has a cross-sectional inclined structure.

As described above, by forming the thickness (S) of the positive mixture layer 130′ not covered with the insulating portion 100′ to be larger than the thickness (T) of the first region 100a′ of the insulating portion 100′, the pressing pressure can be sufficiently applied to the positive mixture layer 130′ not covered with the insulating portion 100′, and the manufacturing cost of the insulating portion 100′ can be reduced. Although the thickness (S) of the positive mixture layer 130′ is formed to be larger than the thickness (T) of the first region 100a′ of the insulating portion 100′, the second region 100b′ of the insulating portion 100′ covers the positive mixture layer 130′. The total thickness (U) of the positive mixture layer 130′ covered with the second region 100b′ of the insulating portion 100′ and the second region 100b′ has a cross-sectional inclined structure toward the total thickness (U′) of the positive mixture layer 130′ covered with the second region 100b′ of the insulating portion 100′ and the second region 100b′ so that the thin insulating portion 100′ easily covers the positive mixture layer 130′ thicker than the insulating portion 100′.

In the positive electrode 13′ of the present embodiment, a part of the insulating portion 100′ may be formed between the positive mixture layer 130′ and the positive electrode current collector 13a′.

The material of the electrode group 5′ of the present embodiment is similar to that of the electrode group 5 of the first embodiment.

In the electrode group 5′ of the second embodiment described above, the end portion 150a′ of the negative mixture layer 150′ is provided at a position facing the second region 100b′ of the insulating portion 100′. As a result, even when the end portion 150a′ of the negative mixture layer 150′ breaks through the separator 4′, the second region 100b′ of the insulating portion 100′ faces the end portion 150a′ of the negative mixture layer 150′, and thus it is possible to suppress a short circuit between the negative mixture layer 150′ and the positive mixture layer non-coated portion 70a′.

In the electrode group 5′ of the second embodiment, in the positive mixture layer 130′ at the position facing the end portion 150a′ of the negative mixture layer 150′, the second region 100b′ of the insulating portion 100′ covers at least a part of the positive mixture layer 130′. As a result, it is possible to obtain the electrode group 5′ securing a sufficient capacity while suppressing the self-discharge of the positive electrode 13′ due to the elution of the metal ions contained in the positive mixture layer 130′.

### Third Embodiment

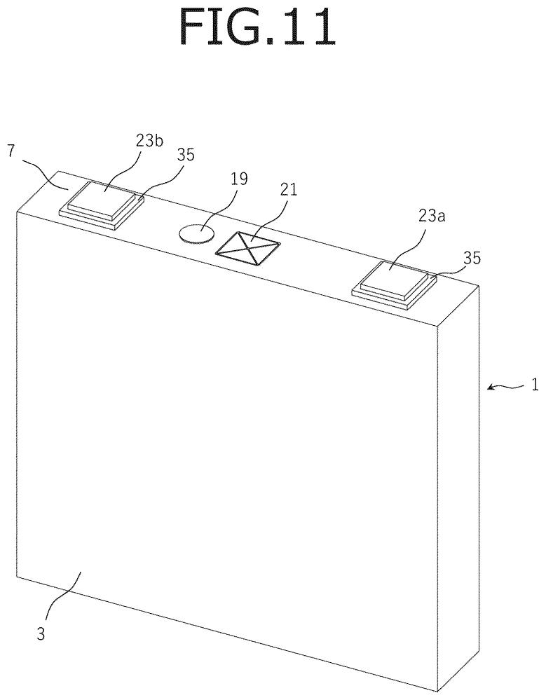

A secondary battery 1 of a third embodiment will be described with reference to FIG. 11. FIG. 11 is a perspective view schematically showing the secondary battery 1 according to the third embodiment.

As shown in FIG. 11, the secondary battery 1 includes an exterior case 3, and the electrode group 5 having a wound structure of the first embodiment is housed inside the exterior case 3. Inside the exterior case 3, the electrode group 5 is impregnated with an electrolyte solution (not shown), the electrolyte solution is injected from, for example, an injection port (not shown) provided in a lid member 7, and the injection port is closed by a sealing plate 19 after the injection of the electrolyte solution. As the electrolyte solution, a nonaqueous electrolyte solution prepared by dissolving an electrolyte (for example, a lithium salt) in a nonaqueous solvent is used. The nonaqueous solvent may be used singly or in combination of two or more kinds thereof.

On the surface of the lid member 7, a gas release valve 21 may be provided together with the sealing plate 19. Furthermore, for example, a pair of external terminals 23 is attached to the surface of the lid member 7, and the external terminals 23 are formed of a conductive material such as metal. One of the external terminals 23 is a positive electrode external terminal 23a, the other is a negative electrode external terminal 23b, and the external terminals 23 are electrically connected to the positive mixture layer non-coated portion 70a and the negative mixture layer non-coated portion 70b of the electrode group 5, respectively. A terminal insulator 35 may be provided between the external terminal 23 and the lid member 7 in order to maintain insulation between the external terminal and the lid member.

The secondary battery 1 of the third embodiment described above includes the electrode group 5 of the first embodiment. As a result, even when the end portion 150a of the negative mixture layer 150 breaks through the separator 4 in the electrode group 5, the second region 100b of the insulating portion 100 faces the end portion 150a of the negative mixture layer 150, and thus it is possible to provide the secondary battery 1 that can suppress a short circuit between the negative mixture layer 150 and the positive mixture layer non-coated portion 70a.

In the electrode group 5, in the positive mixture layer 130 at the position facing the end portion 150a of the negative mixture layer 150, the second region 100b of the insulating portion 100 covers at least a part of the positive mixture layer 130, so that it is possible to provide the secondary battery 1 securing a sufficient capacity while suppressing the self-discharge of the positive electrode 13 due to the elution of metal ions contained in the positive mixture layer 130.

### Fourth Embodiment

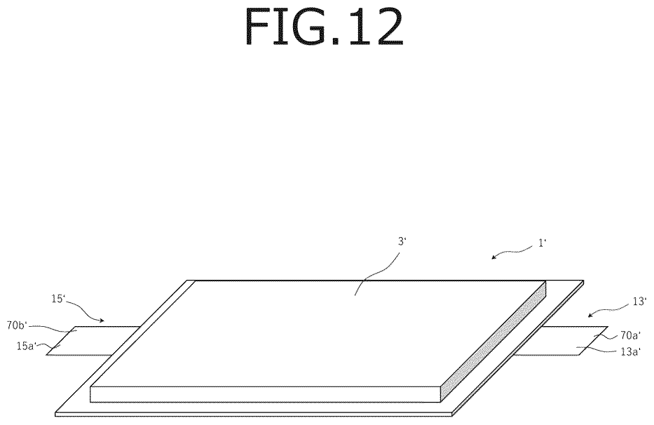

A secondary battery 1′ of a fourth embodiment will be described with reference to FIG. 12. FIG. 12 is a perspective view schematically showing the secondary battery 1′ according to the fourth embodiment.

As shown in FIG. 12, the secondary battery 1′ includes an exterior case 3′, and the electrode group 5′ having a stacked structure of the second embodiment is housed inside the exterior case 3′. Inside the exterior case 3′, the electrode group 5′ is impregnated with an electrolyte solution (not illustrated).

The secondary battery 1′ of the fourth embodiment described above includes the electrode group 5′ of the second embodiment. As a result, even when the end portion 150a′ of the negative mixture layer 150′ breaks through the separator 4′ in the electrode group 5′, the second region 100b′ of the insulating portion 100′ faces the end portion 150a′ of the negative mixture layer 150′, and thus it is possible to provide the secondary battery 1′ that can suppress a short circuit between the negative mixture layer 150′ and the positive mixture layer non-coated portion 70a′.

In the electrode group 5′, in the positive mixture layer 130′ at the position facing the end portion 150a′ of the negative mixture layer 150′, the second region 100b′ of the insulating portion 100′ covers at least a part of the positive mixture layer 130′, so that it is possible to provide the secondary battery 1′ securing a sufficient capacity while suppressing the self-discharge of the positive electrode 13′ due to the elution of metal ions contained in the positive mixture layer 130′.

According to the electrode group 5 of at least one embodiment described above, the end portion 150a of the negative mixture layer 150 is provided at a position facing the second region 100b of the insulating portion 100. As a result, even when the end portion 150a of the negative mixture layer 150 breaks through the separator 4, the second region 100b of the insulating portion 100 faces the end portion 150a of the negative mixture layer 150, and thus it is possible to suppress a short circuit between the negative mixture layer 150 and the positive mixture layer non-coated portion 70a.

In the electrode group 5 of at least one embodiment, in the positive mixture layer 130 at the position facing the end portion 150a of the negative mixture layer 150, the second region 100b of the insulating portion 100 covers at least a part of the positive mixture layer 130. As a result, it is possible to obtain the electrode group 5 securing a sufficient capacity while suppressing the self-discharge of the positive electrode 13 due to the elution of the metal ions contained in the positive mixture layer 130.

Although some embodiments of the present invention have been described, these embodiments have been presented as examples, and are not intended to limit the scope of the invention. These embodiments can be implemented in various other forms, and various omissions, substitutions, and changes can be made without departing from the gist of the invention. These embodiments and modifications thereof are included in the scope and gist of the invention, and are included in the invention described in the claims and the equivalent scope thereof.

### EXAMPLES

Examples will be described below, but the present invention is not limited to Examples described below without departing from the scope of the invention.

### Example 1

A secondary battery 1 of Example 1 was produced by the following procedure.

### <Method for Producing Positive Electrode 13>

As a compound (positive active material) in a positive mixture layer, a lithium-nickel-cobalt-manganese composite oxide represented by LiNi0.8Co0.1Mn0.1O2 was prepared. The positive active material, polyvinylidene fluoride as a binder, and carbon black as a conductive agent were prepared so as to have a mixing ratio of 100 parts by mass (93% by mass):2 parts by mass (2% by mass):5 parts by mass (5% by mass). The positive active material, the binder, the conductive agent, and N-methyl-pyrrolidone (NMP) were charged into a planetary mixer. All the charged materials were stirred with the planetary mixer to obtain a positive mixture slurry.

Alumina was prepared as insulating particles. The alumina and the polyvinylidene fluoride as the binder were prepared so that the mixing ratio was 100 parts by mass (85% by mass):15 parts by mass (15% by mass). The alumina, the binder and the NMP were charged into the planetary mixer. All the charged materials were stirred with the planetary mixer to obtain an alumina slurry.

The positive mixture slurry was applied to both surfaces of a positive electrode current collector 13a made of an aluminum foil, and the alumina slurry was applied to both surfaces of the positive electrode current collector 13a so as to cover an interface between a positive mixture layer 130 and a positive mixture layer non-coated portion 70a, and the coating film was dried. Here, the relationship (B1/A1) between the length A1 of the positive mixture layer 130 not covered with alumina and the length B1 of alumina was 0.02. The relationship (B1′/B1) between the length B1 of alumina and the length B1′ of the second region 100b of alumina was 0.3. The dried coating film was subjected to a roll press treatment. Thus, a positive electrode 13 including the positive mixture layer 130 formed on both the surfaces of the positive electrode current collector 13a and having an electrode density (not including the positive electrode current collector 13a) of 3.3 g/cm3 and alumina was produced.

### <Method for Producing Negative Electrode 15>

As a compound (negative active material) in a negative mixture layer, lithium titanate having a spinel type crystal structure represented by Li4Ti5O12 was prepared. The negative active material, polyvinylidene fluoride as a binder, and carbon black as a conductive agent were prepared so as to have a mixing ratio of 100 parts by mass (94% by mass):2 parts by mass (2% by mass):4 parts by mass (4% by mass). The negative active material, the binder, the conductive agent, and N-methyl-pyrrolidone (M4P) were charged into a planetary mixer. All the charged materials were stirred with the planetary mixer to obtain a negative mixture slurry.

The negative mixture slurry was applied to both surfaces of a negative electrode current collector 15a made of an aluminum foil, and the coating film was dried. Furthermore, the dried coating film was subjected to a roll press treatment. Thus, a negative electrode 15 including the negative mixture layer 150 formed on both the surfaces of the negative electrode current collector 15a and having an electrode density (not including the negative electrode current collector 15a) of 2.1 g/cm3 was produced.

### <Production of Electrode Group 5>

An electrode group 5 having a wound structure was produced by winding the positive electrode 13 and the negative electrode 15 produced above with a separator 4 interposed therebetween. At this time, a second region 100b of an insulating portion 100 was made to face an end portion 150a of the negative mixture layer 150.

### <Preparation of Nonaqueous Electrolyte Solution>

As a mixed solvent, a mixed solvent of propylene carbonate and diethyl carbonate (volume ratio 33:53) was prepared. In this solvent, lithium hexafluorophosphate (LiPF6) was dissolved at a concentration of 14% by mass. Thus, a nonaqueous electrolyte solution was prepared.

### <Assembly>

The electrode group 5 and the nonaqueous electrolyte solution produced as described above were housed in an exterior case 3, and the case was sealed to assemble 1000 secondary batteries 1.

### <Measurement of 0.2 C Discharge Capacity>

The 0.2 C discharge capacity of the secondary battery 1 was checked in the following procedure. First, the secondary battery was subjected to constant current charge (CC charge) at 1 C until the battery voltage reached 2.7 V, and then to constant voltage charge (CV charge) at 2.7 V until the current value reached 0.05 C. The secondary battery in this state was subjected to discharge at a constant current of 0.2 C until the battery voltage reached 1.5 V, and the discharge capacity in this discharge was defined as the 0.2 C discharge capacity.

### <Measurement of Short Circuit Rate>

After the 0.2 C discharge capacity was measured, the short circuit rates of the 1000 secondary batteries 1 were confirmed. Using a tester, the secondary battery 1 having a resistance of several milliohms was regarded as a short circuit.

### Example 2

The relationship (B1/A1) between the length A1 of a positive mixture layer 130 not covered with alumina and the length B1 of alumina is 0.01, and the other conditions are the same as those in Example 1.

### Example 3

The relationship (B1/A1) between the length A1 of a positive mixture layer 130 not covered with alumina and the length B1 of alumina is 0.04, and the other conditions are the same as those in Example 1.

### Example 4

The relationship (B1/A1) between the length A1 of a positive mixture layer 130 not covered with alumina and the length B1 of alumina is 0.005, and the other conditions are the same as those in Example 1.

### Example 5

The relationship (B1/A1) between the length A1 of a positive mixture layer 130 not covered with alumina and the length B1 of alumina is 0.05, and the other conditions are the same as those in Example 1.

### Example 6

The relationship (B1′/B1) between the length B1 of alumina and the length B1′ of a second region 100b of alumina is 0.1, and the other conditions are the same as those in Example 1.

### Example 7

The relationship (B1′/B1) between the length B1 of alumina and the length B1′ of a second region 100b of alumina is 0.5, and the other conditions are the same as those in Example 1.

### Example 8

The relationship (B1′/B1) between the length B1 of alumina and the length B1′ of a second region 100b of alumina is 0.7, and the other conditions are the same as those in Example 1.

### Comparative Example 1

The relationship (B1′/B1) between the length B1 of alumina and the length B1′ of a second region 100b of alumina is 0, the second region 100b of alumina is not formed, and the other conditions are the same as those in Example 1.

### Comparative Example 2

Alumina is not formed, a positive mixture layer 130 is configured to face the end portion 150a of a negative mixture layer 150, and the other conditions are the same as those in Example 1.

### Comparative Example 3

A negative active material is graphite, and the other conditions are the same as those in Example 1.

Table 1 shows the short circuit rate and the 0.2 C discharge capacity in each of Examples and Comparative Examples.

TABLE 1

| | | | | | Short | 0.2 C |
|---|---|---|---|---|---|---|
| | Negative | | | Insulating | circuit | discharge |
| | electrode | B1/A1 | B1′/B1 | layer | rate | capacity/Ah |
| Example 1 | Li₄Ti₅O₁₂ | 0.02 | 0.3 | Presence | 0.0 | 20.78 |
| Example 2 | Li₄Ti₅O₁₂ | 0.01 | 0.3 | Presence | 0.1 | 20.80 |
| Example 3 | Li₄Ti₅O₁₂ | 0.04 | 0.3 | Presence | 0.0 | 20.74 |
| Example 4 | Li₄Ti₅O₁₂ | 0.005 | 0.3 | Presence | 1.0 | 20.61 |
| Example 5 | Li₄Ti₅O₁₂ | 0.05 | 0.3 | Presence | 0.0 | 20.02 |
| Example 6 | Li₄Ti₅O₁₂ | 0.02 | 0.1 | Presence | 0.1 | 20.71 |
| Example 7 | Li₄Ti₅O₁₂ | 0.02 | 0.5 | Presence | 0.0 | 20.63 |
| Example 8 | Li₄Ti₅O₁₂ | 0.02 | 0.7 | Presence | 0.1 | 20.20 |
| Comparative | Li₄Ti₅O₁₂ | 0.02 | 0 | Presence | 0.2 | 20.49 |
| Example 1 | | | | | | |
| Comparative | Li₄Ti₅O₁₂ | — | — | Absence | 10 | 20.64 |
| Example 2 | | | | | | |
| Comparative | Graphite | 0.02 | 0.3 | Presence | 100 | 0 |
| Example 3 | | | | | | |

As shown in Table 1, in Examples 1 to 8, the short circuit rate is as low as 0.0 to 1.0%, and the 0.2 C discharge capacity is also sufficient. From this, it was verified that when alumina has the first region 100a and the second region 100b, and the second region 100b of alumina faces the end portion 150a of the negative mixture layer 150, a short circuit between the negative mixture layer 150 and the positive mixture layer non-coated portion 70a can be suppressed, and the 0.2 C discharge capacity can also be sufficiently obtained.

Among Examples 1 to 8, particularly as in Examples 1 to 3 and Examples 6 to 8, when the relationship (B1/A1) between the length A1 of the positive mixture layer 130 not covered with alumina and the length B1 of alumina is 0.01 or more and 0.04 or less, the short circuit rate is as very low as 0.0 to 0.1%. In Example 4, the short circuit rate was as low as 1.0%, but the short circuit rate was higher than that in the case where (B1/A1) was 0.01 or more and 0.04 or less. From this, it was verified that when the length B1 of alumina is minute with respect to the length A1 of the positive mixture layer 130 not covered with alumina, the second region 100b of the insulating portion 100 does not face the end portion 150a of the negative mixture layer 150, and it is difficult to suppress a short circuit between the negative mixture layer 150 and the positive mixture layer non-coated portion 70a.

In Example 5, the 0.2 C discharge capacity was less than that in the case where (B1/A1) was 0.01 or more and 0.04 or less. From this, it was verified that when the relationship (B1/A1) between the length A1 of the positive mixture layer 130 not covered with alumina and the length B1 of alumina is 0.05 or more, the ratio of alumina to the entire electrode group 5 increases, and the 0.2 C discharge capacity decreases.

From the above, it was verified that a preferable range of the relationship (B1/A1) between the length A1 of the positive mixture layer 130 not covered with alumina and the length B1 of alumina is 0.01 or more and 0.04 or less from the viewpoint of preventing the short circuit and securing the discharge capacity.

Furthermore, with respect to the relationship (B1/A1) between the length A1 of the positive mixture layer 130 not covered with alumina and the length B1 of alumina, the short circuit rate in Example 2 was slightly higher than that in Example 1. Therefore, it was verified that a more preferable relationship (B1/A1) between the length A1 of the positive mixture layer 130 not covered with alumina and the length B1 of alumina is 0.015 or more and 0.04 or less.

Subsequently, among Examples 1 to 8, particularly as in Examples 1 to 3, and 6 and 7, the relationship (B1/A1) between the length A1 of the positive mixture layer 130 not covered with alumina and the length B1 of alumina was 0.01 or more and 0.04 or less, and the relationship (B1′/B1) between the length B1 of alumina and the length B1′ of the second region 100b of alumina was 0.1 or more and 0.5 or less, so that the short circuit rate was low, and the 0.2 C discharge capacity was also sufficiently obtained. In Example 8, the short circuit rate was as low as 0.1%, but the 0.2 C discharge capacity was less than that in the case where (B1′/B1) was 0.1 or more and 0.5 or less. From this, it was verified that when the relationship (B1′/B1) between the length B1 of alumina and the length B1′ of the second region 100b of alumina is 0.7 or more, the second region 100b of alumina cannot be sufficiently pressed in the step of pressing the positive electrode 13, the electrode thickness of the entire positive electrode 13 increases, and accordingly, the number of windings of the electrode group 5 decreases, and the 0.2 C discharge capacity decreases.

Furthermore, with respect to the relationship (B1′/B1) between the length B1 of alumina and the length B1′ of the second region 100b of alumina, the 0.2 C discharge capacity of Example 7 was slightly less than that of Examples 1 to 3 and 6, and thus it was verified that a more preferable relationship (B1′/B1) between the length B1 of alumina and the length B1′ of the second region 100b of alumina is 0.1 or more and 0.3 or less.

In Comparative Example 1, the 0.2 C discharge capacity is less than that of Examples 1 to 3. From this, it was verified that by not forming the second region 100b of the insulating portion 100, the elution of metal ions contained in the positive mixture layer 130 occurs in the positive mixture layer 130 at a position facing the end portion 150a of the negative mixture layer 150, and the self-discharge of the positive electrode 13 proceeds.

In Comparative Example 2, the short circuit rate is higher than that in Examples. From this, it was verified that when the positive mixture layer 130 is configured to face the end 150a of the negative mixture layer 150 without forming the insulating portion 100, the short circuit between the negative mixture layer 150 and the positive mixture layer non-coated portion 70a cannot be suppressed.

In Comparative Example 3, the short circuit rate is significantly higher than that in Examples, and charging and discharging cannot be performed due to the short circuit. This is because the lithium ion insertion/extraction potential of graphite is about 0.1 V (vs. Li/Li+) as a potential based on metal lithium, and lithium metal is deposited on the graphite by charging and discharging. It was verified that the lithium metal breaks through the separator 4 and a short circuit occurs between the positive electrode 13 and the negative electrode 15.

The above results are used for the electrode group 5 of the present embodiment. Specifically, the insulating portion 100 covering the interface between the positive mixture layer non-coated portion 70a and the positive mixture layer 130 is formed on the positive electrode current collector 13a. The relationship (B1/A1) between the length A1 of the positive mixture layer 130 not covered with the insulating portion 100 and the length B1 of the insulating portion 100 is 0.01 or more and 0.04 or less. The relationship (B1′/B1) between the length B1 of the insulating portion 100 and the length B1′ of the second region 100b of the insulating portion is 0.1 or more and 0.5 or less.

In the electrode group 5 of the present embodiment, the end portion 150a of the negative mixture layer 150 is provided at a position facing the second region 100b of the insulating portion 100 covering at least a part of the positive mixture layer 130. As a result, even when the end portion 150a of the negative mixture layer 150 breaks through the separator 4, the second region 100b of the insulating portion 100 faces the end portion 150a of the negative mixture layer 150, and thus it is possible to suppress a short circuit between the negative mixture layer 150 and the positive mixture layer non-coated portion 70a.

Furthermore, the negative mixture layer 150 preferably contains a compound having a lithium ion insertion/extraction potential of 0.4 V (vs. Li/Li+) or more as a potential based on metal lithium, and lithium metal deposited by charging and discharging does not break through the separator 4, so that the occurrence of a short circuit between the positive electrode 13 and the negative electrode 15 can be suppressed.

In the electrode group 5 of the present embodiment, in the positive mixture layer 130 at the position facing the end portion 150a of the negative mixture layer 150, the second region 100b of the insulating portion 100 covers at least a part of the positive mixture layer 130. As a result, it is possible to obtain the electrode group 5 securing a sufficient capacity while suppressing the self-discharge of the positive electrode 13 due to the elution of the metal ions contained in the positive mixture layer 130.

What is claimed is:

1. An electrode group comprising
a positive electrode and a negative electrode, wherein
the positive electrode and the negative electrode are wound with a separator interposed therebetween,
the positive electrode includes: a band-shaped positive electrode current collector having a long side and a short side; a positive mixture layer in which a positive mixture is applied onto the positive electrode current collector in parallel with the long side of the positive electrode current collector; a positive mixture layer non-coated portion in which the positive mixture is not applied; and an insulating portion covering an interface between the positive mixture layer and the positive mixture layer non-coated portion, and
the negative electrode includes: a band-shaped negative electrode current collector having a long side and a short side; and a negative mixture layer in which a negative mixture is applied onto the negative electrode current collector in parallel with the long side of the negative electrode current collector, wherein
the insulating portion has a first region covering at least a part of the positive mixture layer non-coated portion and a second region covering at least a part of the positive mixture layer, and
an end portion parallel to a long side of the negative mixture layer is provided at a position facing the second region of the insulating portion.

2. An electrode group comprising
a positive electrode and a negative electrode, wherein
the positive electrode and the negative electrode are stacked with a separator interposed therebetween,
the positive electrode includes: a rectangular positive electrode current collector having a long side and a short side; a positive mixture layer in which a positive mixture is applied onto the positive electrode current collector in parallel with the short side of the positive electrode current collector; a positive mixture layer non-coated portion in which the positive mixture is not applied; and an insulating portion covering an interface between the positive mixture layer and the positive mixture layer non-coated portion, and
the negative electrode includes: a rectangular negative electrode current collector having a long side and a short side; and a negative mixture layer in which a negative mixture is applied onto the negative electrode current collector in parallel with the short side of the negative electrode current collector, wherein
the insulating portion has a first region covering at least a part of the positive mixture layer non-coated portion and a second region covering at least a part of the positive mixture layer, and
an end portion parallel to a short side of the negative mixture layer is provided at a position facing the second region of the insulating portion.

3. The electrode group according to claim 1, wherein
a length A1 of the positive mixture layer not covered with the insulating portion in a width direction parallel to a short side of the positive mixture layer and a length B1 of the insulating portion in the width direction satisfy a relationship of the following formula (1):
$$0.01 \leq B 1 / A 1 \leq 0 \text{.04} . \qquad ( 1 )$$

4. The electrode group according to claim 2, wherein
a length A2 of the positive mixture layer not covered with the insulating portion in a width direction parallel to a long side of the positive mixture layer and a length B2 of the insulating portion in the width direction satisfy a relationship of the following formula (2):
$$0.01 \leq B 2 / A 2 \leq 0 \text{.04} . \qquad ( 2 )$$

5. The electrode group according to claim 1, wherein
a length B1 of the insulating portion in a width direction parallel to a short side of the positive mixture layer and a length B1′ of the second region of the insulating portion in the width direction satisfy a relationship of the following formula (3):
$$0.1 \leq B {1}^{′} / B 1 \leq 0.5 . \qquad ( 3 )$$

6. The electrode group according to claim 2, wherein
a length B2 of the insulating portion in a width direction parallel to a long side of the positive mixture layer and a length B2′ of the second region of the insulating portion in the width direction satisfy a relationship of the following formula (4):
$$0.1 \leq B {2}^{′} / B 2 \leq 0.5 . \qquad ( 4 )$$

7. The electrode group according to claim 1, wherein
a thickness of the positive mixture layer not covered with the insulating portion is larger than a thickness of the first region of the insulating portion.

8. The electrode group according to claim 1, wherein
a total thickness of the positive mixture layer covered with the second region of the insulating portion and the second region is reduced toward the first region of the insulating portion.

9. The electrode group according to claim 1, wherein
the insulating portion contains insulating particles.

10. The electrode group according to claim 9, wherein
the insulating portion includes at least one selected from the group consisting of alumina and zirconia.

11. The electrode group according to claim 1, wherein
the negative mixture contains a compound having a lithium ion insertion/extraction potential of 0.4 V (vs. Li/Li+) or more as a potential based on metal lithium.

12. The electrode group according to claim 11, wherein
the negative mixture layer contains at least one of lithium titanate having a spinel type crystal structure represented by Li4+xTi5O12 (−1≤x≤3), lithium titanate having a ramsdellite-type crystal structure represented by Li2+xTi3O7 (−1≤x≤3), a niobium-titanium composite oxide having a monoclinic crystal structure represented by LixNb2TiO7 (0≤x≤5), and a metal composite oxide containing Ti and at least one element selected from the group consisting of P, V, Sn, Cu, Ni, and Fe.

13. The electrode group according to claim 2, wherein
a thickness of the positive mixture layer not covered with the insulating portion is larger than a thickness of the first region of the insulating portion.

14. The electrode group according to claim 2, wherein
a total thickness of the positive mixture layer covered with the second region of the insulating portion and the second region is reduced toward the first region of the insulating portion.

15. The electrode group according to claim 2, wherein
the insulating portion contains insulating particles.

16. The electrode group according to claim 15, wherein
the insulating portion includes at least one selected from the group consisting of alumina and zirconia.

17. The electrode group according to claim 2, wherein
the negative mixture contains a compound having a lithium ion insertion/extraction potential of 0.4 V (vs. Li/Li+) or more as a potential based on metal lithium.

18. The electrode group according to claim 17, wherein
the negative mixture layer contains at least one of lithium titanate having a spinel type crystal structure represented by Li4+xTi5O12 (−1≤x≤3), lithium titanate having a ramsdellite-type crystal structure represented by Li2+xTi3O7 (−1≤x≤3), a niobium-titanium composite oxide having a monoclinic crystal structure represented by LixNb2TiO7 (0≤x≤5), and a metal composite oxide containing Ti and at least one element selected from the group consisting of P, V, Sn, Cu, Ni, and Fe.

19. A secondary battery comprising:
the electrode group according to claim 1; and
an electrolyte solution.

20. A secondary battery comprising:
the electrode group according to claim 2; and
an electrolyte solution.
